(19) United States
(12) Patent Application Publication
(10) Pub. No.: US 2013/0254039 A1
(43) Pub. Date: Sep. 26, 2013

(54) METHOD AND APPARATUS FOR PROVIDING ADVERTISEMENT SERVICE IN MOBILE COMMUNICATION SYSTEM

(71) Applicant: Tae-Yoon Kim, Suwon-si (KR)

(72) Inventor: Tae-Yoon Kim, Suwon-si (KR)

(73) Assignee: SAMSUNG ELECTRONICS CO. LTD., Suwon-si, Gyeonggi-do (KR)

(21) Appl. No.: 13/991,010

(22) PCT Filed: Dec. 13, 2011
(86) PCT No.: PCT/KR2011/009583

§ 371 Date: May 31, 2013

(30) Foreign Application Priority Data
Dec. 13, 2010 (KR) 10-2010-0126827

(51) Int. Cl. G06Q 30/02

(52) U.S. Cl. CPC G06Q 30/0267
USPC 705/14.64

(57) ABSTRACT

Provided is a method and apparatus for providing an advertisement service in a mobile communication system. A method of a server for providing an advertisement service in a mobile communication system includes receiving a message for requesting to provide an advertisement corresponding to an advertisement board to a terminal, searching at least one advertisements corresponding to the advertisement board, determining an advertisement corresponding to user attributes of the terminal among the searched advertisements, and transmitting the determined advertisement to an external device.

### TECHNICAL FIELD

The present invention relates generally to a mobile communication system, and in particular, to a method and apparatus for providing an advertisement service in a mobile communication system.

### BACKGROUND ART

Augmented Reality (AR) is a technology for augmenting reality by overlaying a virtual image onto a real-world image. Because the AR technology mixes a real-world image and a virtual-word image with additional information, it is also called Mixed Reality (MR).

As the use of mobile communication terminals has recently increased, advertisement services using the AR technology has attracted attention. Accordingly, a variety of AR advertisement services are provided. For example, when an advertisement provider provides a Quick Response (QR) code corresponding to a desired advertisement, a user recognizes the QR code received through a camera of a mobile terminal, and the advertisement corresponding to the QR code is displayed on the mobile terminal.

However, the conventional AR-based advertisement service may be unsuitable for some users because it shows the same advertisement regardless of the user attributes of mobile terminals. For example, adult advertisements may be provided to adolescent users of mobile terminals. Also, due to the characteristics of advertisements, it may be difficult to interest users in viewing advertisements through their own mobile terminals.

### DISCLOSURE OF INVENTION

### Solution to Problem

An object of the present invention is to substantially solve at least the above problems and/or disadvantages and to provide at least the advantages below. Accordingly, an object of the present invention is to provide a method and apparatus for providing an advertisement service in a mobile communication system.

Another object of the present invention is to provide a method and apparatus for providing an advertisement service corresponding to user attributes in a mobile communication system.

Another object of the present invention is to provide a method and apparatus for allowing a mobile terminal to detect an IC tag included in an advertisement board and receive advertisements suitable for user attributes in a mobile communication system.

Another object of the present invention is to provide a method and apparatus for allowing a mobile terminal to detect advertisement ID information and receive advertisements suitable for user attributes in a mobile communication system.

Another object of the present invention is to provide a method and apparatus for retaining various advertisements corresponding to various user attributes, for respective advertisement items and providing advertisements corresponding to user attributes of mobile terminals in a mobile communication system.

According to an aspect of the present invention, a method of a server for providing an advertisement service in a mobile communication system includes: receiving a message for requesting to provide an advertisement corresponding to an advertisement board to a terminal; searching at least one advertisements corresponding to the advertisement board; determining an advertisement corresponding to user attributes of the terminal among the searched advertisements; and transmitting the determined advertisement to an external device.

According to another aspect of the present invention, a method of a mobile terminal for providing an advertisement service in a mobile communication system includes: detecting a peripheral advertisement board; transmitting an advertisement request message including user information to the peripheral advertisement board when an advertisement view event for the peripheral advertisement board is generated from a user; and receiving an advertisement corresponding to the peripheral advertisement board.

According to another aspect of the present invention, a method of an advertisement board for providing an advertisement service in a mobile communication system includes: transmitting a signal indicating an advertisement product through an IC tag at predetermined periods; receiving an advertisement request message including user information from a user through the IC tag; and transmitting a message for requesting to provide an advertisement corresponding to the advertisement board to the terminal corresponding to the received user information, to a local register server.

### BRIEF DESCRIPTION OF DRAWINGS

The above and other objects, features and advantages of the present invention will become more apparent from the following detailed description when taken in conjunction with the accompanying drawings in which:

FIG. 1 is a block diagram of a mobile communication system according to an exemplary embodiment of the present invention;

FIG. 2 is a signal flow diagram illustrating a signal flow for an advertisement service in a mobile communication system according to an exemplary embodiment of the present invention;

FIG. 3 is a block diagram of a mobile communication system according to another exemplary embodiment of the present invention;

FIG. 4 is a signal flow diagram illustrating a signal flow for an advertisement service in a mobile communication system according to another exemplary embodiment of the present invention;

FIG. 5 is a block diagram of a mobile terminal, an advertisement board, and a local register server according to an exemplary embodiment of the present invention;

FIG. 6 is a block diagram of a network provider server according to an exemplary embodiment of the present invention;

FIG. 7 is a block diagram of an advertisement provider server according to an exemplary embodiment of the present invention;

FIG. 8 is a flow diagram illustrating a process for receiving an advertisement service by a mobile terminal according to an exemplary embodiment of the present invention;

FIG. 9 is a flow diagram illustrating a process of an IC tag included in an advertisement board according to an exemplary embodiment of the present invention;

FIG. 10 is a flow diagram illustrating a process of a local register server according to an exemplary embodiment of the present invention;

FIG. 11 is a flow diagram illustrating a process of a network provider server according to an exemplary embodiment of the present invention; and

FIG. 12 is a flow diagram illustrating a process of an advertisement provider server according to an exemplary embodiment of the present invention.

### BEST MODE FOR CARRYING OUT THE INVENTION

Exemplary embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

The present invention provides a method and apparatus for providing an advertisement service corresponding to user attributes of a mobile terminal in a mobile communication system. In the following description, the mobile terminal may be any mobile device that has a wireless communication function and a camera. Also, the advertisement board may be any advertisement means that contains information such as messages or images relevant to commercial products. Examples of the advertisement board include an advertisement board installed on the surface of a wall of a subway platform, an advertisement board installed on the surface of a wall of a bus stop, an advertisement board installed in a subway train or a bus, an advertisement board installed on a building, paper pages (e.g., a magazine and a newspaper), and mobile advertisement means or products. The advertisement board may include information representing relevant advertisements. For example, the advertisement board may include information identifying advertisements provided by relevant advertisement boards, such as advertisement board ID, product ID, and advertisement ID. For example, the advertisement board may include an IC tag having an advertisement board ID, or advertisement ID information (e.g., bar code or QR code). Also, the advertisement may include commercial images, videos, characters, and voices.

Hereinafter, a description will be given of the case where the advertisement board includes an IC tag, and the case where the advertisement board includes advertisement ID information.

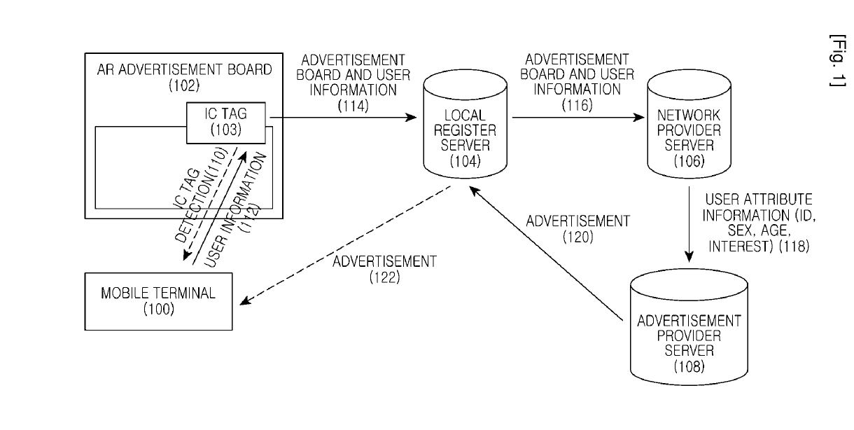

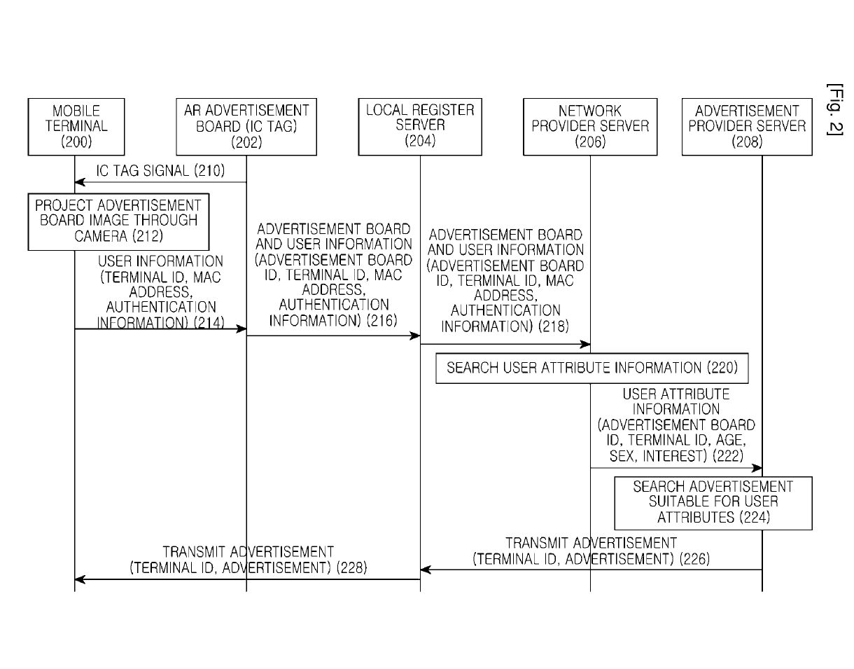

First, the case where the advertisement board includes an IC tag will be described below with reference to FIGS. 1 and 2.

FIG. 1 is a block diagram of a mobile communication system according to an exemplary embodiment of the present invention.

Referring to FIG. 1, a mobile communication system may include a mobile terminal (hereinafter simply referred to as ‘terminal’) 100, an AR advertisement board (hereinafter simply referred to as ‘advertisement board’) 102, a local register server 104, a network provider server 106, and an advertisement provider server 108.

When an AR advertisement function is executed, the terminal 100 receives a signal from a peripheral IC tag 103, detects the presence of a peripheral advertisement board, and displays the presence of the peripheral advertisement board, in step 110. Herein, information included in the signal received from the IC tag 103 may be used to indicate what product the peripheral advertisement board advertises. Thereafter, when an image of the advertisement board 102 is projected through a camera according to a user's operation or when an input for viewing an advertisement of the advertisement board 102 is generated, the terminal 100 transmits user information to the IC tag 103 to request an advertisement corresponding to the user information, in step 112. Herein, the user information may include a unique ID of the terminal 100 (hereinafter simply referred to as ‘terminal ID’), a MAC address, and authentication information. Thereafter, in step 122, the terminal 100 receives an advertisement (or advertisement contents) from the local register server 104 connected to the IC tag 103 included in the advertisement board 102, and plays and provides the received advertisement to the user.

The advertisement board 102 may include advertisement information about at least one product. The advertisement board 102 includes the IC tag 102 and communicates with the terminal 100 and the local register server 104. That is, the IC tag 103 included in the advertisement board 103 may transmit a signal including information about the product at predetermined periods in step 110. When receiving an advertisement request message including user information from the terminal 100 in step 112, the IC tag 103 requests an advertisement corresponding to the user information among the advertisements corresponding to the advertisement board 102 by transmitting the received user information and advertisement board ID indicating the advertisement board to the local register server 104 connected in a wired or wireless manner, in step 114.

The local register server 104 is connected to a plurality of IC tags 103. When receiving an advertisement request message including advertisement board ID and user information from each IC tag 103, the local register server 104 provides the received information to the network provider server 106 in step 116. At this point, the local register server 104 may be connected to the network provider server 106 in a wired manner. Thereafter, the local register server 104 receives an advertisement, which will be provided to the terminal 100, from the advertisement provider server 108 in step 120, and transmits the received advertisement to the terminal 100 in step 122. Herein, the local register server 104 may receive an advertisement and an ID of a terminal, which will receive the advertisement, from the advertisement provider server 108 and transmit the received advertisement to the terminal corresponding to the user ID.

The network provider server 106 may manage communication in the network. The network provider server 106 may perform authentication about each of terminals in the network, and prestore user attribute information about each of the terminals. Herein, the user attribute information may include the user's age, sex, occupation, residence and interest. When receiving an advertisement request message including advertisement board ID and user information from the local register server 104, the network provider server 106 searches user attribute information corresponding to the received user information. Thereafter, in step 118, the network provider server 106 transmits an advertisement request message including the user attribute information, the user ID, and the advertisement board ID to the advertisement provider server 108.

The advertisement provider server 108 stores advertisements about products, and stores advertisements of different features about each product. For example, as for a product A, the advertisement provider server 108 may store a first advertisement appealing to male users and a second advertisement appealing to female users. As for a product B, the advertisement provider server 108 may store a first advertisement appealing to office workers, a second advertisement appealing to housewives, and a third advertisement appealing to students. That is, as for each product, the advertisement provider server 108 may retain a plurality of advertisements in consideration of user attributes (e.g., age, sex, occupation, residence, and interest).

When receiving an advertisement request message including the user attribute information, the user ID, and the advertisement board ID from the network provider server 106, the advertisement provider server 108 searches at least one products corresponding to the advertisement board ID, and determines an advertisement corresponding to the user attribute information among the searched product advertisements. For example, if an advertisement for students, an advertisement for office workers, and an advertisement for housewives are stored as for a product A corresponding to the advertisement board ID, and if the user attribute information is “Age: 27, Sex: male, Occupation: office worker, Residence: Seoul, Interest: book”, the advertisement provider server 108 may determine the advertisement for office workers because the user is an office worker. Also, if there are products A and B corresponding to the advertisement board ID, if an adolescent advertisement is stored as an advertisement about the product A, if an adult advertisement is stored as an advertisement about the product B, and if the user attribute information is “Age: 27, Sex: male, Occupation: office worker, Residence: Seoul, Interest: book”, the advertisement provider server 108 may determine the adult advertisement because the user is aged 27. Thereafter, in step 120, the advertisement provider server 108 transmits the determined advertisement to the local register server 104. Herein, the advertisement provider server 108 may analyze the advertisement board ID to determine the local register server 104, which will receive the determined advertisement, among a plurality of local register servers.

FIG. 2 is a signal flow diagram illustrating a signal flow for an advertisement service in a mobile communication system according to an exemplary embodiment of the present invention.

Referring to FIG. 2, an advertisement board 202 including an IC tag transmits an IC tag signal including information about an advertisement product at predetermined periods in step 210.

When receiving the IC tag signal during the performance of an AR advertisement function, a terminal 200 displays the presence of a peripheral advertisement board for a specific product and projects an image of the advertisement board 202 through a camera according to a user's operation in step 212. Also, the terminal 200 may receive data indicating an advertisement board view mode from the user without projecting an image of the advertisement board 202 through the camera.

Thereafter, the terminal 200 transmits an advertisement request message including user information to the IC tag of the advertisement board 202 in step 214. Herein, the user information may include a user ID, a MAC address, and authentication information. When receiving the user information, the IC tag of the advertisement board 202 transmits the advertisement board ID and the user information to a local register server 204 installed in a relevant region.

The local register server 204 transmits an advertisement request message including the user information and the advertisement board ID to a network provider server 206 in step 216. Herein, the local register server 204 may be connected to the network provider server 206 in a wired manner.

Thereafter, the network provider server 206 receives the advertisement request message including the user information and the advertisement board ID from the local register server 204 in step 218, and searches user attribute information corresponding to the received user information in step 220. Herein, the user information may include the user's age, sex, occupation, residence, and interest, and may be beforehand received from each terminal. Thereafter, in step 222, the network provider server 206 transmits the searched user attribute information, the user ID, and the advertisement board ID to an advertisement provider server 208.

When receiving an advertisement request message including the user attribute information, the user ID, and the advertisement board ID from the network provider server 206, the advertisement provider server 208 searches at least one products corresponding to the advertisement board ID and determines an advertisement corresponding to the user attribute information among the searched product advertisements, in step 224. Thereafter, in step 226, the advertisement provider server 208 transmits the determined advertisement and the user ID to the local register server 204. Herein, the advertisement provider server 208 may analyze the advertisement board ID to determine the local register server 204, which will receive the determined advertisement, among a plurality of local register servers.

When receiving the advertisement and the user ID from the advertisement provider server 208, the local register server 204 transmits the received advertisement to the terminal 200 corresponding to the user ID in step 228.

The terminal 200 receives the advertisement from the local register server 204, and plays and provides the received advertisement to the user.

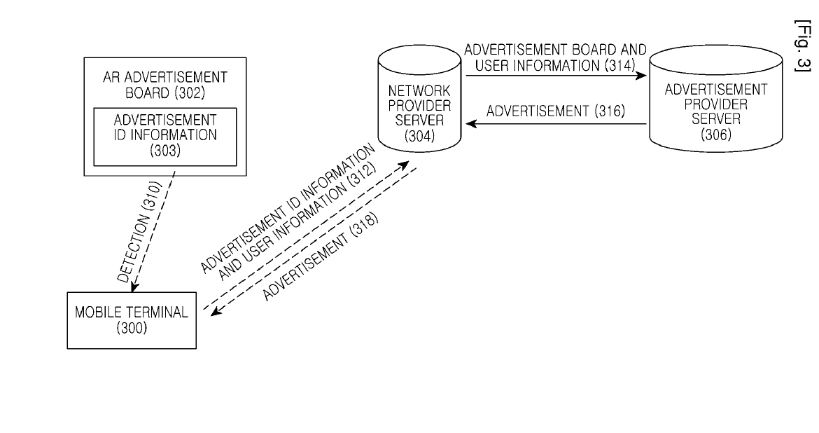

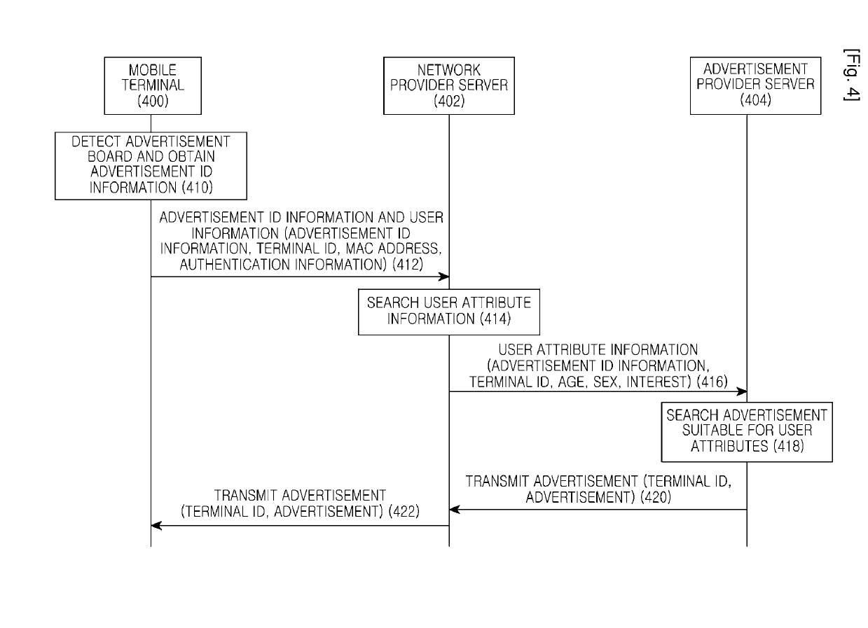

The case where the advertisement board includes advertisement ID information will be described below with reference to FIGS. 3 and 4.

FIG. 3 is a block diagram of a mobile communication system according to another exemplary embodiment of the present invention.

Referring to FIG. 3, a mobile communication system may include a mobile terminal (hereinafter simply referred to as ‘terminal’) 300, an AR advertisement board (hereinafter simply referred to as ‘advertisement board’) 302, a network provider server 304, and an advertisement provider server 306.

When an AR advertisement function is executed by a user, the terminal 300 detects an advertisement board 303 whose image is projected through a camera according to a user's operation, in step 310. For example, the advertisement board 303 may include ID information about an advertisement product, such as a QR code or a bar code. The terminal 300 may detect the QR code or the bar code and obtain ID information about an advertisement product of the advertisement board 303. Upon obtaining the advertisement ID information, the terminal 300 transmits an advertisement request message including user ID information and user information to the network provider server 304 in step 312. In step 318, the terminal 300 receives an advertisement from the network provider server 304, and plays and provides the received advertisement to the user.

The advertisement board 302 may include advertisement information about at least one product. Specifically, the advertisement board 302 may include ID information about an advertisement product. For example, the advertisement board 302 may include the QR code or the bar code as the ID information about the advertisement product. The advertisement board 302 may also include other types of encoded or decoded information.

The network provider server 304 may manage communication in the network. The network provider server 304 may prestore user attribute information about each of the terminals in the network. Herein, the user attribute information may include the user's age, sex, occupation, residence and interest. When receiving an advertisement request message including advertisement ID information and user information from the terminal 300, the network provider server 304 searches user attribute information corresponding to the received user information. If the network provider server 304 may not prestores user attribute information. In this case, the network provider server 304 may receive the user attribute information simultaneously with the advertisement request message of step 312, or may receive the user attribute information by performing an additional operation of requesting the user attribute information.

In step 314, the network provider sever 304 transmits an advertisement request message including the user ID and the advertisement ID information and the user attribute information to the advertisement provider server 306. In step 316, the network provider server 304 receives an advertisement from the advertisement provider server 306. In step 318, the network provider server 304 transmits the received advertisement to the terminal 300.

The advertisement provider server 306 stores various advertisements about products. For example, as for a product A, the advertisement provider server 306 may store a first advertisement appealing to male users and a second advertisement appealing to female users. As for a product B, the advertisement provider server 306 may store a first advertisement appealing to office workers, a second advertisement appealing to housewives, and a third advertisement appealing to students. That is, as for each product, the advertisement provider server 306 may retain a plurality of advertisements in consideration of user attributes (e.g., age, sex, occupation, residence, and interest).

When receiving an advertisement request message including the user attribute information, the user ID, and the advertisement ID information from the network provider server 304, the advertisement provider server 306 searches at least one advertisements corresponding to the advertisement ID information, and determines an advertisement corresponding to the user attribute information among the searched advertisements. For example, if a first advertisement appealing to male users and a second advertisement appealing to female users are stored as for a product A, as advertisements corresponding to the advertisement ID information, and if the user attribute information is “Age: 27, Sex: male, Occupation: office worker, Residence: Seoul, Interest: book”, the advertisement provider server 306 may determine the first advertisement appealing to male users because the user is male. Thereafter, in step 316, the advertisement provider server 304 transmits the determined advertisement to the network provider server 304.

FIG. 4 is a signal flow diagram illustrating a signal flow for an advertisement service in a mobile communication system according to another exemplary embodiment of the present invention.

Referring to FIG. 4, when an AR advertisement function is executed by a user, a terminal 400 detects an advertisement board whose image is projected through a camera according to a user's operation, in step 410. For example, the advertisement board may include ID information about an advertisement product, such as a QR code or a bar code. The terminal 400 may detect the QR code or the bar code and obtain ID information about an advertisement product of the advertisement board. Thereafter, in step 412, the terminal 400 transmits an advertisement request message including the advertisement ID information and user information to a network provider server 402.

Thereafter, the network provider server 402 receives the advertisement request message including the advertisement ID information and the user information from the terminal 400, and searches user attribute information corresponding to the received user information. Herein, the user information may include the user's age, sex, occupation, residence, and interest, and may be beforehand received from each terminal. Thereafter, in step 416, the network provider server 402 transmits an advertisement request message including the searched user attribute information, the user ID, and the advertisement ID information to an advertisement provider server 404.

When receiving an advertisement request message including the user attribute information, the user ID, and the advertisement ID information from the network provider server 402, the advertisement provider server 404 searches at least one products corresponding to the advertisement ID information and determines an advertisement corresponding to the user attribute information among at least one advertisements corresponding to the advertisement ID information, in step 418. Thereafter, in step 420, the advertisement provider server 404 transmits the determined advertisement and the user ID to the network provider server 402.

When receiving the advertisement and the user ID from the network provider server 402, the advertisement provider server 404 transmits the received advertisement to the terminal 400 corresponding to the user ID in step 422.

The terminal 400 receives the advertisement from the network provider server 402, and plays and provides the received advertisement to the user.

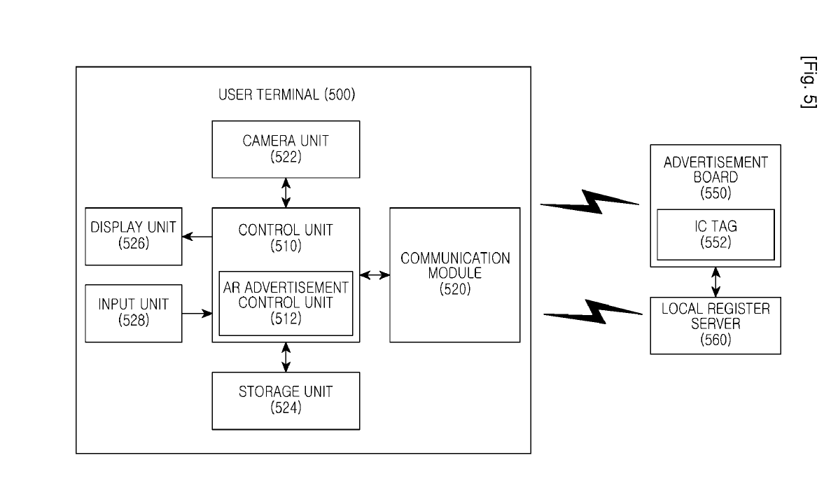

FIG. 5 is a block diagram of a mobile terminal, an advertisement board, and a local register server according to an exemplary embodiment of the present invention.

Referring to FIG. 5, a terminal 500 may include a control unit 510, a communication module 520, a camera unit 522, a storage unit 524, a display unit 526, and an input unit 528. The control unit 510 may include an AR advertisement control unit 512.

The control unit 510 controls an overall operation of the terminal 500. According to the present invention, the control unit 510 receives an advertisement suitable for user attributes through the AR advertisement control unit 512 when an AR advertisement function is performed.

When an AR advertisement function is performed by a user, the AR advertisement control unit 512 detects a peripheral advertisement board, obtains advertisement board ID or advertisement ID information, and transmits the obtained information to a relevant device. When receiving a signal from a peripheral IC tag through the communication module 520, the AR advertisement control unit 512 detects the presence of a peripheral advertisement board and displays the presence of the peripheral advertisement board on the display unit 526. The AR advertisement control unit 512 transmits an advertisement request message including user information to an IC tag 552 included in an advertisement board 550, when an image of the advertisement board 550 is projected through a camera according to a user's operation through the input unit 528 or when an input for viewing an advertisement of the advertisement board 550. Herein, the user information may include the user ID, MAC address, and authentication information.

When an advertisement detection event is generated according to a user's control through the input unit 528, the AR advertisement control unit 512 detects an image received from the camera unit 522, obtains advertisement ID information, and transmits an advertisement request message including the advertisement ID information to a network provider server.

When receiving an advertisement (or advertisement contents) through the communication module 520 from a local register server 560 or a network provider server, the control unit 510 plays and provides the received advertisement to the user.

The communication module 520 communicates signals with other devices under the control of the control unit 510. The communication module 520 may include a communication module supporting a broadband wireless communication technology. The communication module 520 may further include a reader for detecting a signal transmitted from the IC tag and transmitting the detected signal to the IC tag, and a module supporting a near-field wireless communication technology.

The camera unit 522 includes a camera sensor. The camera unit 522 converts an optical signal received from the camera sensor into an electrical signal and provides the resulting image frame to the control unit 510.

The storage unit 524 stores various programs and data for the overall operation of the terminal 500. The storage unit 524 stores the terminal ID, MAC address, authentication information.

The display unit 526 displays various state information, numerals, characters, and images that are generated during the operation of the terminal 500. Also, under the control of the control unit 510, the display unit 526 displays an image received from the camera unit 522 and displays an advertisement play screen.

The input unit 528 includes one or more key buttons or touch sensors. The input unit 528 provides the control unit 510 with data corresponding to touched coordinates or keys pressed by the user. The input unit 528 may receive data indicating an AR advertisement function mode from the user, and may include data indicating a mode for viewing an advertisement of a specific advertisement board.

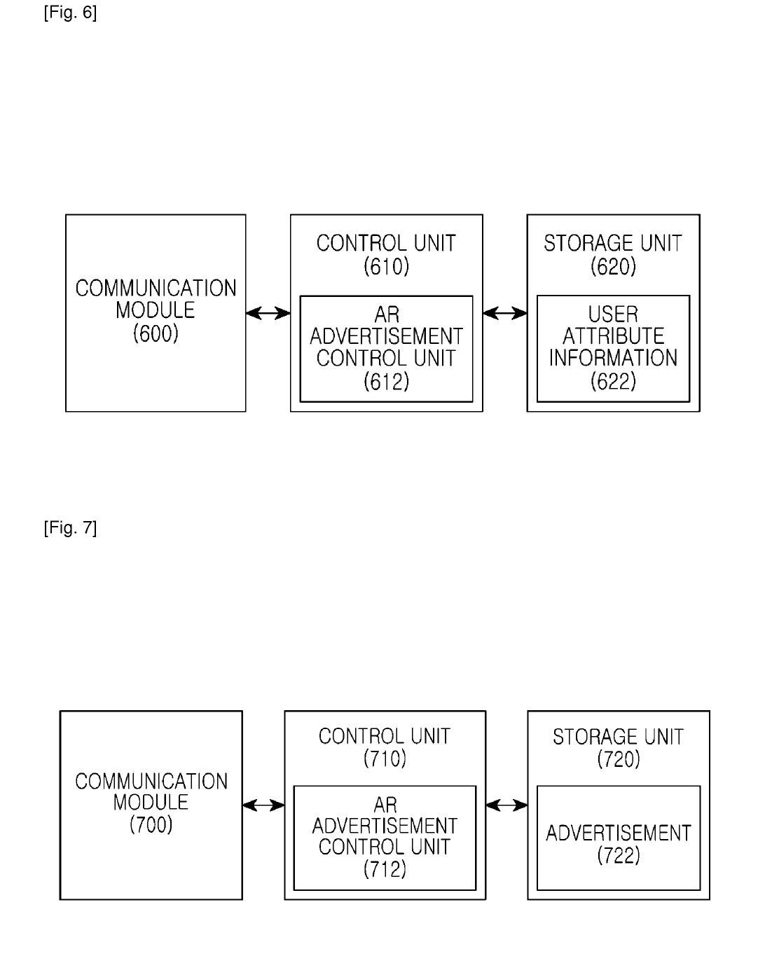

FIG. 6 is a block diagram of a network provider server according to an exemplary embodiment of the present invention.

Referring to FIG. 6, the network provider server may include a communication module 600, a control unit 610, and a storage unit 620. The control unit 610 includes an AR advertisement control unit 612.

Under the control of the control unit 610, the communication module 600 communicates signals with a terminal, a local register server, and an advertisement provider server. The communication module 600 may communicate signals with the terminal by broadband wireless communication, and may communicate signals with the local register server and the advertisement provider server by wired communication.

The control unit 610 controls and processes the functions for managing terminals in the network. The control unit 610 provides an advertisement request message including user attribute information corresponding to user information through the AR advertisement control unit 612 to an advertisement provider server, and transmits an advertisement received from the advertisement provider server to the terminal. When receiving an advertisement request message including user information and advertisement board ID from a local register server, the AR advertisement control unit 612 searches the user attribute information and transmits a message for requesting an advertisement corresponding to the user attribute information to the advertisement provider server. Also, when receiving an advertisement request message including the user information and advertisement ID information from the terminal, the AR advertisement control unit 612 transmits user attribute information corresponding to the user information to the advertisement provider server, receives an advertisement corresponding to the user attribute information from the advertisement provider server, and transmits the received advertisement to the terminal.

The storage unit 620 stores various programs and data for the overall operation of the network provider server. According to the present invention, the storage unit 620 stores user attribute information about each of the terminals in the network. Herein, the user attribute information may include the user's age, sex, occupation, residence, and interest.

FIG. 7 is a block diagram of an advertisement provider server according to an exemplary embodiment of the present invention.

Referring to FIG. 7, the advertisement provider server may include a communication module 700, a control unit 710, and a storage unit 720. The control unit 710 includes an AR advertisement control unit 712.

Under the control of the control unit 710, the communication module 700 communicates signals with a network provider server and a local register server. The communication module 700 may communicate signals with the network provider server and the local register server in a wired manner.

The control unit 710 receives the registration of commercial advertisements, and provides an advertisement at a user's request. At the request of a network provider server, the control unit 710 searches and transmits an advertisement corresponding to user attribute information through the AR advertisement control unit 712. When receiving an advertisement request message including user attribute information and advertisement board ID from the network provider server, the AR advertisement control unit 712 searches at least one advertisements corresponding to the advertisement board ID, determines an advertisement corresponding to the user attribute information among the searched advertisements, and transmits the determined advertisement to the local register server corresponding to the advertisement board ID. Also, when receiving an advertisement request message including user attribute information and advertisement ID information from the network provider server, the AR advertisement control unit 712 searches at least one advertisements corresponding to the advertisement ID information, determines an advertisement corresponding to the user attribute information among the sarched advertisements, and transmits the determined advertisement to the network provider server.

The storage unit 720 stores various programs and data for the overall operation of the advertisement provider server. According to the present invention, the storage unit 720 stores advertisements 722 for respective products. The storage unit 720 may store attributes of the advertisements for the respective products. When there are a plurality of advertisements about a specific product, the storage unit 720 may store attributes indicating whether each advertisement is suitable for a user. For example, the respective advertisements may have attributes such as advertisement target age, advertisement target sex, advertisement target occupation, advertisement target residence, and advertisement target interest.

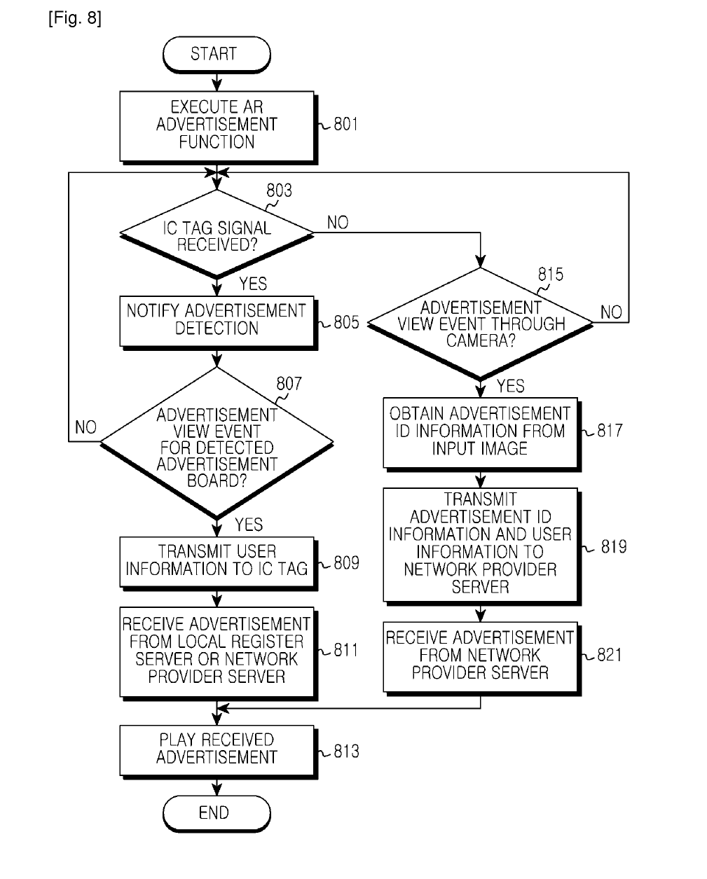

FIG. 8 is a flow diagram illustrating a process for receiving an advertisement service by a mobile terminal according to an exemplary embodiment of the present invention.

Referring to FIG. 8, when an AR advertisement function is executed in step 801, the terminal determines whether a signal is received from a peripheral IC tag. If a signal is received from a peripheral IC tag, the terminal displays the presence of a peripheral advertisement board in step 805. Herein, information included in the signal received from the IC tag may be used to indicate what product the peripheral advertisement board advertises.

In step 807, the terminal determines whether an advertisement view event for the detected advertisement board is generated according to a user's operation. For example, the terminal determines whether an image of an advertisement board is projected through a camera according to a user's operation or a key input or a touch input for viewing an advertisement of the advertisement board is generated. If an advertisement view event for the detected advertisement board is not generated, the terminal return to step 803.

On the other hand, if an advertisement view event for the detected advertisement board is generated, the terminal transmits an advertisement request message including user information to the IC tag in step 809. In step 811, the terminal receives an advertisement from a local register server or a network provider server. Herein, the user information may include the terminal ID, MAC address, and authentication information.

On the other hand, if the IC tag signal is not received, the terminal determines whether an advertisement view event is generated through a camera input image in step 815. For example, the terminal determines whether an event for detecting an advertisement whose image is projected through a camera according to a user's operation. If the advertisement view event is not generated, the terminal returns to step 803.

On the other hand, if the advertisement view event is generated, the terminal detects an image received from the camera according to a predetermined image recognition algorithm, and obtains advertisement ID information, in step 817.

In step 819, the terminal transmits an advertisement request message including advertisement ID information and user information to a network provider server. In step 821, the terminal receives an advertisement from the network provider server.

Thereafter, in step 813, the terminal plays and provides the received advertisement to the user. Thereafter, the terminal ends the algorithm according to the present invention.

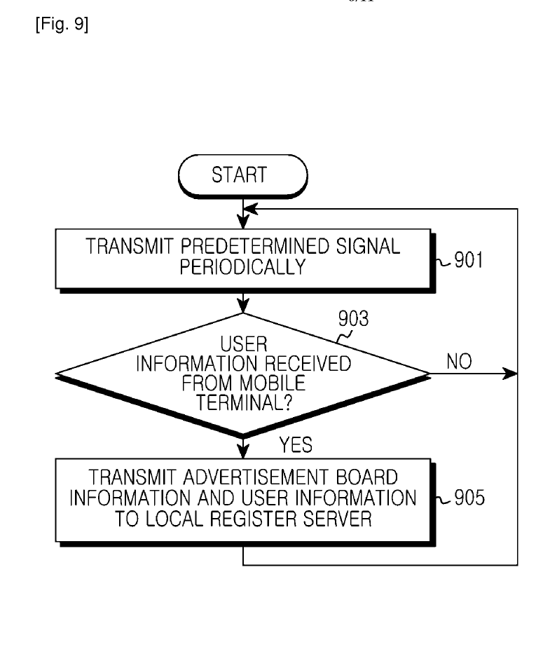

FIG. 9 is a flow diagram illustrating a process of an IC tag included in an advertisement board according to an exemplary embodiment of the present invention.

Referring to FIG. 9, an IC tag included in the advertisement board transmit a signal including information about a product at predetermined periods in step 901. In step 903, the IC tag determines whether an advertisement request message including user information is received from a terminal. If the advertisement request message including user information is not received, the IC tag returns to step 901.

On the other hand, if the advertisement request message including user information is received, the IC tag transmits an advertisement request message including the received user information and an advertisement board ID indicating the advertisement board to a local register server connected in a wired or wireless manner, in step 905. Thereafter, the IC tag returns to step 901.

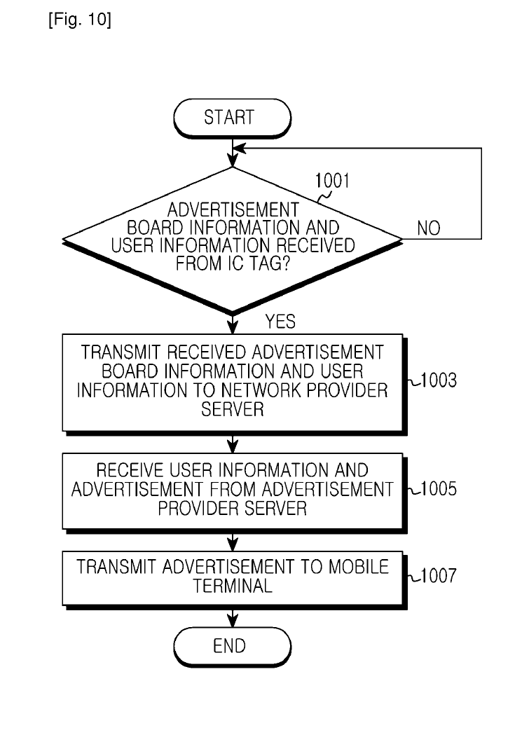

FIG. 10 is a flow diagram illustrating a process of a local register server according to an exemplary embodiment of the present invention.

Referring to FIG. 10, in step 1001, the local register server determines whether an advertisement request message including advertisement board information and user information is received from an IC tag. If the advertisement request message including advertisement board information and user information is received, the local register server transmits an advertisement request message including the received advertisement board information and user information to a network provider server, in step 1003. Herein, the advertisement board information may include advertisement board ID and may include advertisement ID information. The user information received from the IC tag may include the terminal ID, MAC address, and authentication information.

In step 1005, the local register server receives user information and an advertisement from an advertisement provider server. In step 1007, the local register server transmits the received advertisement to the terminal corresponding to the user information. Herein, the user information received from the advertisement provider server may be a terminal ID.

Thereafter, the local register server ends the algorithm according to the present invention.

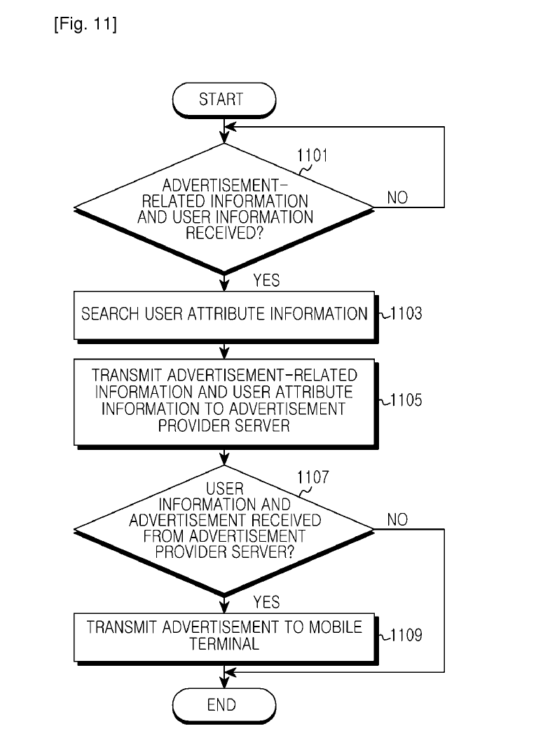

FIG. 11 is a flow diagram illustrating a process of a network provider server according to an exemplary embodiment of the present invention.

Referring to FIG. 11, in step 1101, the network provider server determines whether an advertisement request message including advertisement-related information and user information is received. Herein, the advertisement-related information may include advertisement board ID or advertisement ID information.

If the advertisement request message including advertisement-related information and user information is received, the network provider server searches user attribute information corresponding to the received user information. That is, the network provider server searches user attribute information corresponding to the terminal ID included in the received user information, among the prestored user attribute information. Herein, the user attribute information may include the user's age, sex, occupation, residence, and interest.

In step 1105, the network provider server transmits an advertisement request message including the user attribute information and the advertisement-related information to an advertisement provider server. In step 1107, the network provider server determines whether user information and advertisement are received from the advertisement provider server. If user information and advertisement are not received from the advertisement provider server, the network provider server ends the algorithm according to the present invention.

On the other hand, if user information and advertisement are received from the advertisement provider server, the network provider server transmits the received advertisement to the terminal corresponding to the user information, in step 1109. Thereafter, the network provider server ends the algorithm according to the present invention.

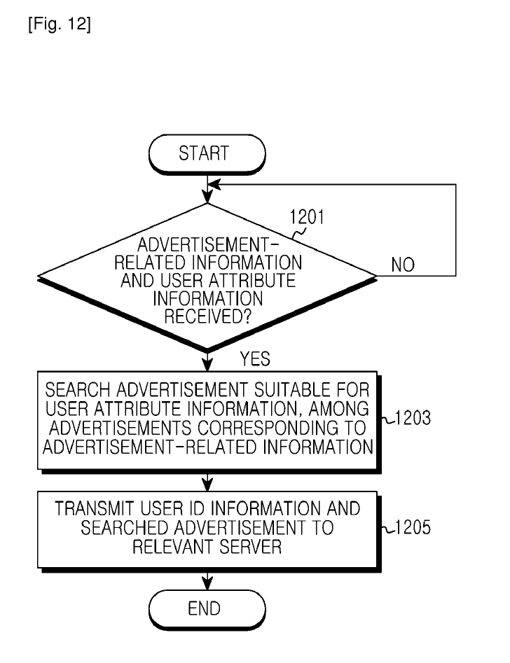

FIG. 12 is a flow diagram illustrating a process of an advertisement provider server according to an exemplary embodiment of the present invention.

Referring to FIG. 12, in step 1201, the advertisement provider server determines whether an advertisement request message including advertisement-related information and user attribute information is received. Herein, the advertisement-related information may include advertisement board ID or advertisement ID information. Also, the advertisement provider server may receive a terminal ID simultaneously with the user attribute information.

If the advertisement request message including advertisement-related information and user attribute information is received, the advertisement provider server determines an advertisement suitable for the user attribute among the advertisements corresponding to the advertisement-related information, in step 1203. For example, if there are a male advertisement and a female advertisement about a product A, and if the user is male, the advertisement provider server may determine the male advertisement. Thereafter, in step 1205, the advertisement provider server transmits the searched advertisement and the user information (terminal ID) to the network provider server or the local register server.

If there are advertisements corresponding to the advertisement-related information but there is no advertisement corresponding to the user attribute information among the advertisements, the advertisement provider server may transmit a signal indicating the absence of a suitable advertisement to the relevant device.

Thereafter, the advertisement provider server ends the algorithm according to the present invention.

Descriptions has been made of the communication signal flow between the terminal, the network provider server and the advertisement provider server in the case where the advertisement board includes an IC tag, and the communication signal flow between the terminal, the network provider server and the advertisement provider server in the case where the advertisement board includes simple advertisement ID information. However, the present invention is not limited the above two embodiments, and various changes may be made therein without departing from the scope of the present invention. For example, if the advertisement board includes an IC tag, the terminal may transmit the user information to the network provider server, instead of transmitting the user information to the IC tag. Also, regardless of whether the advertisement board includes an IC tag or includes advertisement ID information, the terminal may transmit user information by direct communication with the advertisement provider server, and receive an advertisement corresponding to the user information. In this case, the terminal may be required to transmit user attribute information to the advertisement provider server, or the advertisement provider server may be required to prestore user attribute information. It has been described that the advertisement provider server and the network provider server are separated from each other. However, it will be understood that the advertisement provider server and the network provider server may be integrated into one server. That is, the operation of the advertisement provider server and the operation of the network provider server may be performed by one server.

As described above, according to the present invention, the advertisement provider server retains various advertisements corresponding to various user attributes, and the mobile terminal detects the IC tag of the advertisement board or the advertisement ID information and receives an advertisement corresponding to the user attribute among the relevant advertisements. Accordingly, the present invention can interest users in advertisements. Also, the present invention can be effectively used in the market of adult advertisements whose advertisement targets are limited, such as tobaccos and alcoholic liquors.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A method of a server for providing an advertisement service in a mobile communication system, comprising:
receiving a message for requesting to provide an advertisement corresponding to an advertisement board to a terminal;
searching at least one advertisements corresponding to the advertisement board;
determining an advertisement corresponding to user attributes of the terminal among the searched advertisements; and
transmitting the determined advertisement to an external device.

2. The method of claim 1, wherein the user attributes include at least one of age, sex, residence, occupation, and interest.

3. The method of claim 1, wherein the server stores advertisements of different features with respect to each advertisement board.

4. The method of claim 1, wherein the server prestores user attribute information about each terminal, and the method further comprises searching user attribute information of the terminal on the basis of user information of the terminal included in the received message.

5. A method of a mobile terminal for providing an advertisement service in a mobile communication system, comprising:
detecting a peripheral advertisement board;
transmitting an advertisement request message including user information to the peripheral advertisement board when an advertisement view event for the peripheral advertisement board is generated from a user; and
receiving an advertisement corresponding to the peripheral advertisement board.

6. The method of claim 5, wherein detecting the peripheral advertisement board comprises:
receiving a signal from an IC tag include in the peripheral advertisement board.

7. A method of an advertisement board for providing an advertisement service in a mobile communication system, comprising:
transmitting a signal indicating an advertisement product through an IC tag at predetermined periods;
receiving an advertisement request message including user information from a user through the IC tag; and
transmitting a message for requesting to provide an advertisement corresponding to the advertisement board to the terminal corresponding to the received user information, to a local register server.

8. An apparatus of a server for providing an advertisement service in a mobile communication system, comprising:
a receiving unit for receiving a message for requesting to provide an advertisement corresponding to an advertisement board to a terminal;
a control unit for searching at least one advertisements corresponding to the advertisement board and determining an advertisement corresponding to user attributes of the terminal among the searched advertisements; and
a transmitting unit for transmitting the determined advertisement to an external device.

9. The apparatus of claim 8, wherein the user attributes include at least one of age, sex, residence, occupation, and interest.

10. The apparatus of claim 8, wherein the server stores advertisements of different features with respect to each advertisement board.

11. The apparatus of claim 8, wherein the server prestores user attribute information about each terminal, and the control unit searches user attribute information of the terminal on the basis of user information of the terminal included in the received message.

12. An apparatus of a mobile terminal for providing an advertisement service in a mobile communication system, comprising:
a communication module for communicating signals with an external device; and
a control unit for detecting a peripheral advertisement board through the communication module, transmitting an advertisement request message including user information to the peripheral advertisement board when an advertisement view event for the peripheral advertisement board is generated from a user, and receiving an advertisement corresponding to the peripheral advertisement board.

13. The apparatus of claim 12, wherein the communication module receives a signal from an IC tag included in the peripheral advertisement board, and provides the received signal to the control unit.

14. An apparatus of an advertisement board for providing an advertisement service in a mobile communication system, comprising:
an IC tag for transmitting a signal indicating an advertisement product at predetermined periods, receiving an advertisement request message including user information from a user, and transmitting a message for requesting to provide an advertisement corresponding to the advertisement board to the terminal corresponding to the received user information, to a local register server.

15. The apparatus of claim 14, wherein the advertisement board includes at least one of an advertisement board installed on the surface of a wall of a subway platform, an advertisement board installed on the surface of a wall of a bus stop, an advertisement board installed in a subway train or a bus, an advertisement board installed on a building, a paper page, and a mobile advertisement means.
